(19) United States
(12) Patent Application Publication
(10) Pub. No.: US 2007/0195166 A1
(43) Pub. Date: Aug. 23, 2007

(54) Empty ampoule detector system and method

(75) Inventors: Juan C. Delgado, Woodway, TX (US); Lorens Slokovic, Cleburne, TX (US)

Correspondence Address: ALLERGAN, INC., 2525 DUPONT DRIVE, T2-7H, IRVINE, CA, 92612-1599, US

(73) Assignee: Allergan, Inc., Irvine, CA (US)

(21) Appl. No.: 11/361,921

(22) Filed: Feb. 23, 2006

(51) Int. Cl. H04N 7/18

(52) U.S. Cl. 348/94; 348/125

(57) ABSTRACT

A system and method are provided for inspecting and verifying ampoule cards for the presence of composition or solution. An electronic circuit is added to a deflashing assembly which is used to compare the amount of light guided by liquid to that guided by air, and prevents deflashing of an ampoule card containing one or more empty ampoules. The system is structured to be nearly fully automated but preferably includes various human machine interface components for enabling viewing and monitoring of various system processes.

### BACKGROUND

The present invention generally relates to manufacture of pharmaceutical products and more specifically relates to manufacture of ampoule cards.

Ampoule cards are used as containers for aseptic or sterile compositions in the pharmaceutical industries, particularly for the sterile packaging of injectable solutions.

It would be advantageous in a manufacturing facility if only those newly filled ampoule cards which have been verified as containing only filled ampoules are passed to the next stage of manufacture and/or packaging, and those that have not been so verified are automatically rejected. The present invention is especially suitable for high volume automated manufacturing of ampoule cards.

The present invention is directed to a system and method for distinguishing acceptable from unacceptable ampoule cards, deflashing only the acceptable cards, and rejecting any unacceptable cards. This will hasten the manufacturing process of the ampoule cards and ensure that any deflashed cards have been inspected and verified as acceptable. The invention may also extend the useful life of deflashing equipment, for example, sharp edges of deflashing dies used for removing flash and dividing ampoule cards.

### SUMMARY OF THE INVENTION

Accordingly, the present invention provides systems and methods for inspecting ampoule packages, for example, newly-filled ampoule cards, and for verifying the presence of composition, for example, pharmaceutical solution, in the ampoules.

The present systems and methods are especially useful as a component of a larger manufacturing system for ampoule cards.

An ampoule card, as the term is used herein, typically refers to a package for compositions, usually fluid compositions, for example, pharmaceutical solutions and the like. An ampoule card is generally made of a backing material and one or more individual plastic or glass cavities, often referred to as ampoules. Each ampoule usually contains a pre-measured dosage of composition. The composition may be in the form of a liquid, gel, suspension, solution, or combination thereof. The backing material comprises, for example, a laminated cardstock material. The ampoules are spaced apart along a face of the backing material and secured thereto by plastic laminate. Commonly, the composition in the ampoule card may be extracted for medical, pharmaceutical, or cosmetic use by breaking the ampoule or insertion of a tip of a syringe into an individual ampoule and withdrawal of the composition, or any other suitable means as directed by a manufacturer thereof.

In a broad aspect of the invention, a method for inspecting and verifying comprises positioning at least a portion of an ampoule package in an inspection position, i.e. an inspection station, and acquiring a digital image thereof. The digital image is processed and analyzed for an indication of one or more empty ampoules in the package or the portion thereof. More specifically, each ampoule of the imaged package or the portion thereof is analyzed to verify that it is properly filled with the composition. The package may then be passed to a further processing stage if the verification is made that the package or the portion thereof contains only filled ampoules. In the absence of such verification, the package or the portion thereof is determined to be defective.

Verification of whether an ampoule is a filled ampoule may be accomplished in various ways.

In one embodiment, the package or portion thereof in the inspection position is illuminated with a light source and the digital image is acquired during the illumination. Brightness or luminosity of each ampoule in the image is analyzed to determine how much light has passed through the ampoule. This will provide information as to whether the ampoule is filled with the intended composition. For example, the digital image is processed to acquire computer readable data representing brightness or luminosity of each imaged ampoule. The image data can be compared with known data (i.e. control data) to provide a determination of the content of the ampoule in the image.

For example, a computer program is used to compare the image data with the control data. In one aspect of the invention, the control data represents an empty ampoule (e.g. an ampoule primarily filled with air). As light travels differently through different types of media, a similarity between the image data and the control data indicates an empty ampoule. On the other hand, a difference between the image data and the control data indicates an ampoule that is not empty, but contains the desired composition.

In a more specific aspect of the invention, each imaged ampoule is analyzed for the presence of composition, usually liquid composition and is provided with one of a pass status and a fail status. The status data may be displayed on a monitor and/or fed to a computer for use in further processing steps. For example, the system of the invention may assign a pass status to each ampoule that has been verified as containing composition. A fail status may be assigned to each ampoule that has not been verified as containing composition or has otherwise been determined to be empty.

Further, if each and every ampoule of the package of portion of the package in the inspection position has been assigned a pass status, meaning that each ampoule has been determined to contain composition, this information is communicated to a control system which, in response to the information received, activates processing equipment downstream of the inspection station. The equipment may comprise, for example, a deflashing mechanism which deflashed and divides the approved ampoule packages. On the other hand, if the package or the portion thereof has been determined to be defective, the control system operates to cause the package to be rejected. The rejected package may be diverted to a rejection area.

Advantageously, the image of the package or portion thereof in the inspection position may be displayed, for example in real time, on a computer monitor showing the digital image and text conveying the pass or fail status of each ampoule in the image.

The entire system and method may be fully or substantially fully automated, for example, after initial system set up and is preferably designed to be safe and to require very little operator intervention. For example, the system may be activated by responding to sensors which detect the presence of ampoule packages as they arrive in the inspection station, having been conveyed from an ampoule fill station. In addition, the package may be both imaged and digitally processed using a fully integrated vision sensor. The control system includes a programmable logic controller (PLC) which is in communication with the vision sensor via Ethernet.

In another aspect of the invention, the package to be inspected and verified by the systems and methods of the invention may comprise a package composed of a plurality of contiguous portions, each of the portions containing at least one ampoule. The package is passed through a field of view of the vision sensor by means of a conveyor. Consecutive images are taken of the package as each portion passes into the field of view and is individually analyzed, until the entire package has been passed through the field of view.

For example, a first portion of the package is conveyed into a field of view of the vision sensor. The vision sensor acquires and processes a digital image of the portion. The image is analyzed by the vision sensor and a pulse or electronic signal is sent to the controller if the portion is determined to contain only filled ampoules. As the package moves through the field of view, consecutive digital images are acquired and processed and a pulse is sent to the main controller for each portion that has been determined to include only filled ampoules. An encoder keeps track of the positions at which the images are acquired. The number of pulses received is compared to a predetermined number of pass signals expected. If the number of portions received is equal to the number of inspected images, the package is marked as conforming, e.g. approved, good or acceptable. If the number of pulses is less than the number of portions imaged, the package is considered to be non-conforming and is rejected.

In one aspect of the invention, the deflashing mechanism includes a movable, hydraulically operable die, which deflashes and divides the package into the individual portions, each portion containing one or more filled ampoules. The controller instructs the deflashing mechanism to deflash only the conforming packages, i.e. those packages that have been fully inspected and verified as containing only filled ampoules.

In a preferred embodiment, the rejected packages are also sent to the deflashing mechanism, but are not deflashed. Hydraulic operation of the deflashing mechanism allows the controller to cause the deflashing die to move into contact with the rejected package and accurately stop short of deflashing the package. The package is held by the deflashing mechanism and diverted to a rejection bin.

As a specific example, a system for inspecting and verifying ampoule packages along a conveyor in the manufacturing line is provided, the system being located between an ampoule fill station and a deflashing station. A pre-deflashed ampoule package may be a long ampoule card containing, for example, undivided portions comprising five (5) unit dose ampoules per portion. The pre-deflashed long card contains, for example, twenty-five (25) unit dose ampoules. As a long card emerges from a fill station, the present system functions to inspect consecutively, each portion of the long card and each ampoule of each portion and to verify that the portion contains only filled ampoules. If the long card has been determined to be acceptable, that is, none of the ampoules has been detected as empty, the system continues to advance the long card to a further stage of processing. For example, the long card is conveyed to the deflashing station where the portions of the long card are divided, one from the other, resulting in five (5) separate ampoule cards, each ampoule card containing five (5) unit dose ampoules. In the event that the system has detected any portion of the long card to be defective, e.g. any one portion of the long card contains one or more empty ampoules, the entire long card is rejected.

Advantageously, the present systems are programmed in fail safe mode. This is especially important for ampoule packages used for pharmaceutical or medical purposes. In fail safe mode, only ampoule packages logically marked as inspected and verified as containing only filled ampoules will be further processed, for example, deflashed. Any long cards not so inspected and/or verified will be diverted to a rejection bin.

The present systems may be substantially fully automated using appropriate computer processor equipment and software and robotic components.

Advantageously, the digital images of the packages and various calculations and parameters processed in the system may be displayed on one or more human machine interface (HMI) monitors while the system is in use. For example, the vision sensor is able to acquire digital images of the package while the package moves through the field of view and to display those images along with the pass/fail status of each ampoule in the image.

The present systems are also useful for keeping track of numbers and percentages of packages that have rejected by the system. For example, the system may include means of collecting, processing, recording and/or displaying data and human-machine interface equipment for enabling monitoring and analysis of various aspects of the system.

Any and all features described herein and combinations of such features are included within the scope of the present invention provided that the features of any such combination are not mutually inconsistent.

These and other aspects of the present invention are set forth in the following detailed description and claims, particularly when considered in conjunction with the accompanying drawings in which like parts bear like reference numerals.

### BRIEF DESCRIPTION OF THE DRAWINGS

FIGS. 1A and 1B each show a system in accordance with the present invention.

FIG. 2 shows a computer monitor display showing a digital image and analysis of an ampoule package inspected by the present invention.

FIG. 3 is a flow chart detailing a logic routine for an exemplary embodiment of the present invention.

### DETAILED DESCRIPTION

The present invention generally provides methods and systems for inspecting and verifying the presence of a composition in ampoule packages. The present systems and methods are especially useful as a component of a larger manufacturing system for such packages.

In a broad aspect of the invention, the present systems are designed to provide a means for inspecting and verifying the content of ampoule packages, for example, ampoule cards. The packages may be emerging from an ampoule fill station and are passed to the present inspection and verification system in order to ensure that each package contains only filled ampoules.

As used herein, the terminology “filled ampoule” generally includes an ampoule containing at least a minimally acceptable amount of a material that it is intended to contain upon leaving a fill station in a manufacturing line. The material may be a composition, such as a pharmaceutical composition, the composition being in the form of a liquid, gel, particle containing suspension, solution, or any other composition, usually a fluid composition. The term “empty ampoule” as used herein, generally refers to an ampoule that is substantially void of such composition that it is intended to contain, for example is air filled or contains very little of, or less than a desired minimum of the composition.

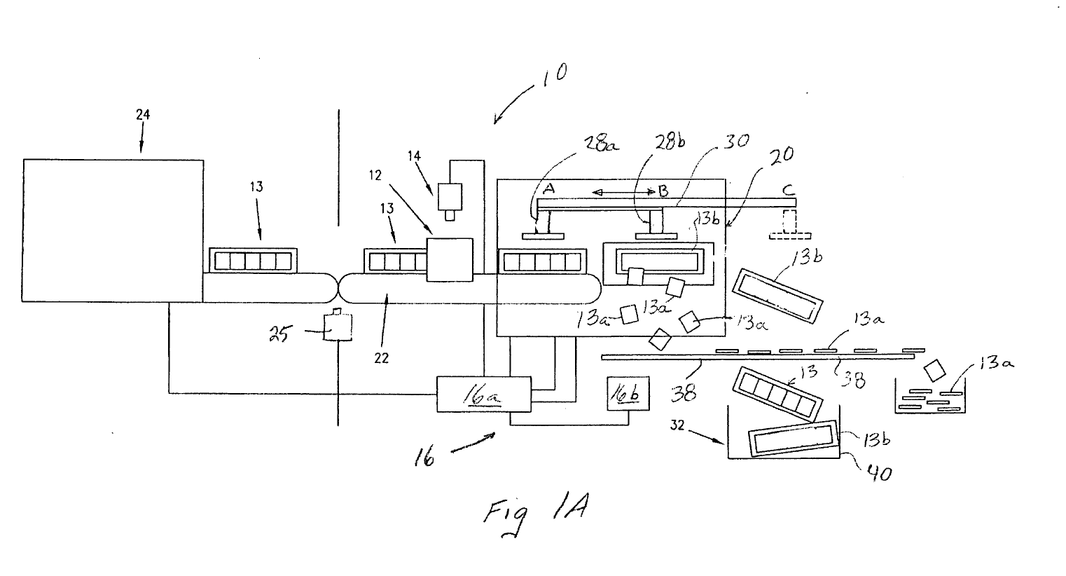

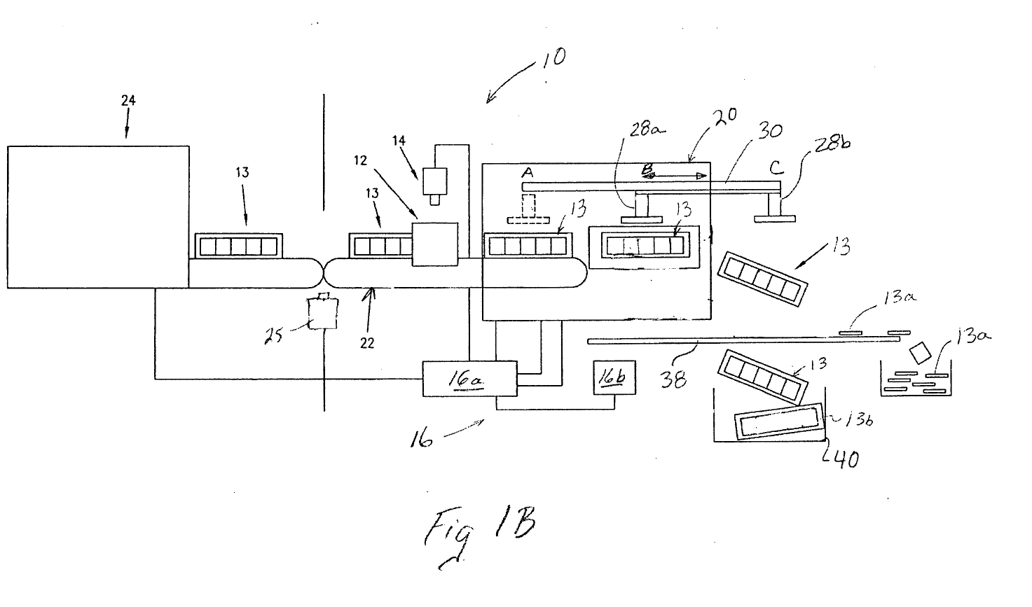

FIGS. 1A and 1B each show a diagram of a preferred system in accordance with the present invention, generally at 10. The system 10 generally comprises an inspection station 12 for receiving packages to be inspected and deflashed, for example, newly filled ampoule packages 13, an optical sensor, preferably an integrated vision sensor 14 for inspecting the packages 13 and acquiring information about, for example digital images of, the packages 13. In this embodiment, the vision sensor 14 is a fully integrated vision sensor including a processor capable of digitally processing the images. The system 10 further comprises a control system 16 in communication with the vision sensor 14, and a deflashing assembly 20 in communication with the control system 16. The control system 16 incorporates a programmable logic controller (PLC) 16a, for example, an Allen-Bradley Flex Logix controller, and a human machine interface (HMI) 16b. The controller 16a is capable of communicating discrete numerical data with the vision sensor 14 via Ethernet.

A conveyor system 22 including a conveyor belt is used to move the packages 13 from a fill station 24 through the inspection station 12 and to the deflashing assembly 20. The system 10 may be programmed to activate on a queue triggered by the packages 13 as they emerge from the fill station 24 and enter a present position upstream of the vision sensor 14. A package 13 in the present position may be sensed by an appropriately placed sensor in communication with the control system 16. For example, a detected absence of a package 13 emerging from the fill station 24 and not reaching a downstream location, for example, the vision sensor, within a specific time will cause the controller 16 to display an alarm message and flash a warning signal.

The vision sensor 14 is preferably a self-contained unit that includes electronic circuits for optical data acquisition, data processing, and interfacing with the control system 16. The vision sensor 14 can perform a number of different functions such as barcode reading, visual defect detection, X/Y coordinate object location, and other functions. In the present invention, the vision sensor 14 performs the functions of an analog or digital camera for capturing images, a processor for converting the images into digitally readable information, and a computer interface card. The processor of the vision sensor 14 contains a program for processing the data received from the camera. The processed data is communicated to the processor 16a of the control system 16 which can signal various other parts of the system 10 depending upon the information received.

As shown, the package 13 is moved by the conveyor 22 into an inspection position such that at least a portion of the package is within a field of view of the vision sensor 14. An encoder provides means for tracking the position of the package 13. The encoder signals the control system 16 indicating that that the package 13 or portion thereof is in the correct position. The controller 16 responds by triggering the vision sensor 14 to acquire a digital image of the package 13 or portion thereof within the field of view. The image is processed and electronic data is sent to the control system 16. For example, if the vision sensor 14 has determined that the package or portion thereof that has been imaged contains only filled ampoules, a signal or pulse is sent to the control system 16.

Advantageously, the vision sensor 14 is capable of analyzing each ampoule in the package and making a determination of whether the ampoule is a filled ampoule or is an empty ampoule as defined hereinabove. Generally, the invention accomplishes this by comparing the amount of light guided by the composition in a filled ampoule to the amount of light guided by air in an empty ampoule. For example, the vision sensor 14 may be programmed to detect luminosity or brightness of the ampoule and compare the luminosity or brightness to control data representing an empty ampoule. Such control data and image data may be in the form of numerical values. The control data may be acquired by calibrating the system, for example, by imaging an empty ampoule (a control ampoule) and analyzing the image to derive a control data value representing brightness or luminosity thereof. The control data is stored in the processor, for example, the vision sensor processor.

In this example, it can be appreciated that if the image data and the control data are similar or within a close range of being identical to one another, i.e. a calculated difference value (DIFF value) between data values is relatively small or zero, the imaged ampoule can be determined to be empty. On the other hand, if the difference between the image data and the control data is substantial or falls within a predetermined range of relatively large DIFF values, the imaged ampoule can be determined to be filled with composition. Generally speaking, a relatively large difference in luminosity between a control representing an empty ampoule and the imaged ampoule will indicate a presence of a liquid composition while a similarity in luminescence will indicate an absence of liquid composition.

In another aspect of the invention, the inspection station 12 further operates by passing light through the package or portion, for example, by pulsing a light source (not shown) beneath the package or portion thereof into the field of view during the imaging of the package or portion thereof. The inspection may operate most effectively in a controlled lighting environment. The field of view is preferably shielded from external light to preserve integrity of the imaging and data derived from the image.

When the vision sensor 14 determines that the package 13 or portion thereof conforms to a predetermined standard or meets a condition or conditions, for example, contains only filled ampoules, the control system 16 is signaled and instructed to cause downstream mechanisms to treat the package as a conforming package. Likewise, in the absence of such a signal or upon receipt of a different signal from the vision sensor, the control system is instructed to treat the package as a non-conforming package, for example, the package is discarded.

In the specific embodiment shown, the controller 16 is programmed to control operation of the deflashing assembly 20 in response to information derived from the images captured by the vision sensor 14.

Still referring to FIGS. 1A and 1B, a package 13 conveyed from the inspection station 12 is gripped or held by a first gripper mechanism 28 in a “pick position” A, While the package is held, the gripper mechanism 28a is moved by arm 30 into a “punch position” B where it will be deflashed.

In order to expedite processing of packages 13, deflashing assembly 20 includes a second gripper mechanism 28b, which is one step ahead of first gripper mechanism 28a during the operation. In other words, when first gripper 28a is in the pick position A, the second gripper mechanism 28b is in the punch position B as shown in FIG. 1A. Referring briefly now to FIG. 1B, when the arm 30 moves first gripper mechanism 28a to punch position B, the second gripper mechanism 28b is moved to a “drop position” C. The arm 30 therefore slides back and forth in the direction of the double headed arrow shown during the operation.

Referring now specifically to FIG. 1A, if the package 13 had been determined from the processed images to be a conforming package, (e.g. the entire package is determined to contain only filled ampoules), the controller 16 instructs the deflashing assembly 20 to punch, or deflash, the package 13 in position B. Deflashing of the package 13 involves utilizing movable dies or the like to divide the package 13 into smaller segments or portions 13a, and/or remove flash 13b, for example, an edge segment, from the package 13. The dies operate, for example, by means of a double acting, hydraulic solenoid valve. The punched portions 13a, which are the ampoule containing product, are allowed to drop, for example, onto a conveyor 38, and be moved downstream for further processing and/or packaging. While the portions 13a drop, the flash 13b is retained by the gripper 28a as shown. The gripper 28a is then moved into drop position C and the flash 13b is deposited into bin 40.

Turning now to FIG. 1B, the system 10 is shown in operation when the controller 16 has instructed the deflashing assembly 20 to treat the package 13 as non-conforming. As explained hereinabove, in this specific embodiment, the package is considered to be non-conforming when the package 13 having been inspected by the vision sensor 14 has been determined to contain one or more empty ampoules. The package 13 is moved to punch position B. The controller 16 has not signaled the deflashing assembly to punch the package, so the package is moved, intact, to drop position C. The undeflashed package 13 is diverted from the manufacturing line, for example, is deposited in bin 40.

In one aspect of the invention, rejection of a package 13 may be achieved by holding the rejected package 13 in punch position B without causing deflashing thereof. More specifically, this may be achieved by allowing the package to pass to the deflashing assembly 20 and stopping a moving portion of the deflasher from completing a full deflashing cycle. For example, the deflashing assembly 20 may be comprised of a first die and a second die. The first die is made of movable parts. When a package is rejected, the controller causes a movable part of the first die to move only partially into a full stroke, such that the first die presses the package 13 against the second die without completing the deflashing motion. Thus, deflashing of the package does not take place. While deflashed packages are automatically released from the dies after being deflashed, the undeflashed packages are diverted from the conveyor.

The system 10 thus prevents deflashing of any package that has passed through the vision sensor field of view and has been determined to contain one or more empty ampoules. The rejected package containing one or more empty ampoules is stopped before the package completes travel beyond the deflashing station. In the shown embodiment, the stopped package is held by the deflashing assembly without being deflashed, until the gripper mechanism, which normally disposes of plastic flash, removes the entire undeflashed package from the processing line.

A false reject ratio (good packages rejected as bad) will preferably be no greater than about 1.5%. A false reject ratio that is greater than 1.5% may be indicative of a malfunction in the system and the need for maintenance thereof.

The control system 16 may be composed of the following hardware components: a Vision Sensor Model No. InSight 1000, manufactured by Cognex; a human machine interface (HMI); a PLC and the following PLC components and connectors: PLC ENET; Isolated Analog I/O); 24 VDC Sink Input; a high speed encoder, 24VDC Source output; 120 VAC Output; ENET remote adapter; 24 VDC Sink Input; T/C Input Module, all hardware except the Vision Sensor is provided by Allen-Bradley. Appropriate software is used for downloading the initial setup includes: Insight PC Host for the Vision Sensor, Panel Builder 32 for the HMI, and RS Logix 5000 and Control Flash for the PLC.

The system 10 is capable of running with a supply of 105-120 VAC from a single phase line. The system 10 is designed to pull a maximum of about 5 Amps.

An operator panel may be located adjacent to deflasher assembly 20. The system 10 is configured to meet strict safety requirements. Among other appropriate safety measures, the system 10 may include clearly labeled start and stop, emergency stop, reset buttons and alarms.

### EXAMPLE

System 10 is used for verifying and deflashing “long cards” in a manufacturing line. A long card, as used herein, refers to pre-deflashed product having ampoules recently filled with a solution. A long card includes a total of twenty-five (25) ampoules. The long card comprises five (5) undivided portions that are to be divided one from the other by being punched with deflashing mechanism 20. It can be appreciated therefore, that after a long card is deflashed, the product will consist of five separate portions hereinafter usually “ampoule cards” each ampoule card including five (5) ampoules. Only long cards having twenty five (25) filled ampoules will be deflashed.

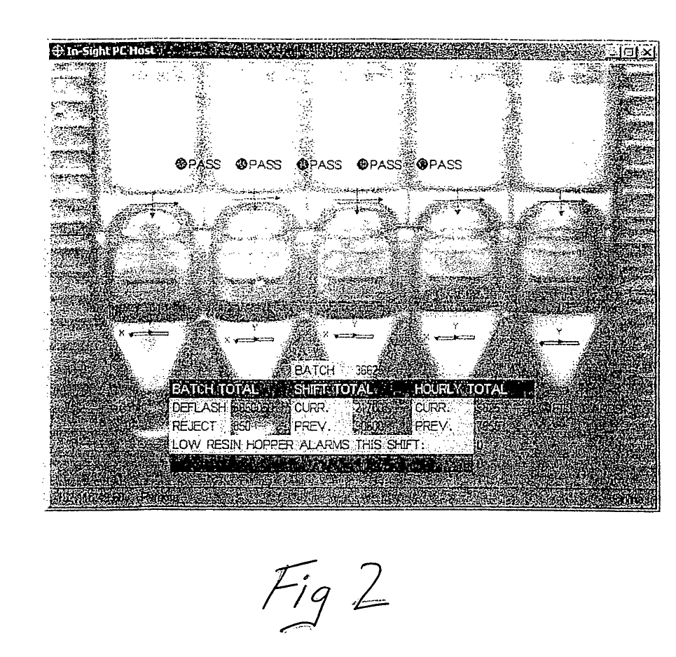

FIG. 2 provides a flow chart showing logic steps used for verifying and deflashing long cards in accordance with this EXAMPLE.

As a long card is moved into the inspection station 12, a sensor in communication with the control system 16 detects the presence of the leading edge of the long card 13 entering the field of view. The control system 16 instructs the vision sensor 14 to capture an image of a first portion of the long card when the card has moved a distance X into the field of view. Distance X is the distance the long card has to travel before the long card will be correctly positioned for the first image to be taken. When the card has traveled distance X from the leading edge, a portion containing five (5) ampoules will be in the field of view. The vision sensor processes the image of the first portion. If the image indicates that all of the five (5) ampoules in the image are filled ampoules, a first pulse is registered by an encoder in the control system 16.

This process is repeated as the long card is moved through the field of vision until each five (5) ampoule portion of the long card is imaged. The PLC 16a counts the pass pulses and compares the number of pulses with the number of imaged portions. If the numbers are equal, meaning every imaged portion of the long card has been determined to show only filled ampoules, the long card is marked “good”. The logical structure of system 10 is such that in the absence of five pulses or signals to the control system 16, deflashing of the long card does not take place. Consequently, any good long cards that have missed the inspection process will be considered by the control system to be “bad” and will be discarded.

In this example, the deflashing mechanism is able to punch one long card in about 8 seconds. The system 10 may be configured to run substantially automatically based on demand from the fill station 24.

The control system 16 is programmed to be capable of useful calculations for display to an operator of the system 10. Some data and calculations for display may include, for example, current lot/batch number, previous lot/batch number, calculation of deflashed ampoules since start of a shift, calculation of deflashed ampoule cards start of the shift, number of long cards deflashed in previous day, number of ampoules deflashed on previous day, number of ampoule cards deflashed on previous day, calculation of deflashed ampoules in current batch, calculation of deflashed ampoule cards in current batch, calculation of rejected long cards in current batch, calculation of rejected ampoule cards in current batch, calculation of deflashed ampoules in current hour/previous hour, calculation of calculation of deflashed ampoule cards in current hour/previous hour, calculation of deflashed long cards in current hour/previous hour, etc.

In addition, the system 10 is capable of providing numerical data indicating pass/fail status of individual ampoules on each ampoule card. This data can be compiled and used for troubleshooting. The time of rejection of the last identified bad long card is displayed and the pass or fail status of each ampoule thereof.

The vision sensor is in communication with one or more human interface panels. Digital images of the portions of the long card may be displayed along with the pass/fail status of each ampoule in the imaged portion. An example of the monitor display is shown in FIG. 2.

The main controller 16 of the system 10 will be exercised by the PLC 16a. The PLC contains the following routines:

| Name of Routine | Description |
|---|---|
| MainRoutine | Enables each of the subroutines. |
| AlarmsDeflasher | Contains logic for the HMI alarms |
| | related to the deflashing operation. |
| AlarmsFiller | Contains logic for the HMI alarms |
| | related to inputs coming from the fill station. |
| AlarmsInspect | Contains logic for the HMI alarms |
| | related to the vision sensor. |
| AlarmsMisc | Contains logic for miscellaneous HMI |
| | alarms. |
| AmpouleTracker | Identifies pass/fail status of |
| | individual ampoule in a long card. |
| Counters | Contains logic for the pulse counter. |
| Deflash | Contains logic that runs the deflasher |
| | during normal operation. |
| InfeedBelt | Contains logic that controls speed of |
| | the infeed belt and contains logic that |
| | displays the portion of a passed long |
| | card on HMI. |
| Inspection | Contains logic that runs the inspection |
| | operation. |
| Temperatures | Contains logic for processing |
| | temperatures of appropriate parts of the |
| | system and for display and |
| | interpretation. |

Each of these routines will now be described in greater detail.
MainRoutine

The main routine (MAINROUTINE) enables all the other program routines. In its roll of master program, it contains logic that disables the other routines when necessary. Alarms subroutines for deflasher mechanism, fill station and inspection station do not run when the machine is in test mode.

Subroutines for miscellaneous alarms, tracking of ampoules, product counters, infeed belt and temperatures are not interrupted because they do not interact with the physical movement of the machine or do not pose any danger to operators of the machine.

The routine that controls deflashing is disabled when a safety guard is open or the machine is in test mode.

The routine that controls the inspection station is disabled when the machine is in test mode or when the vision inspection is intentionally bypassed by the operator.

AlarmsDeflasher

The AlarmsDeflasher routine contains logic to display messages regarding the deflashing of the long cards. These alarm messages involve reasons why the machine can not run, why it is idle, why actuators that are not responding to output signals and other conditions that are suspect and require the operator's attention.

AlarmsFiller

The AlarmsFiller routine contains logic for the alarms associated with the fill station. Such alarms will indicate to the operator if any guards are open, if a jam is suspected, or if fill material is low or empty.

AlarmsInspect

The AlarmsInspect routine contains logic related to the display of messages related to the vision inspection process.

This routine alerts operators if the vision sensor stops operating, if there are jams at the inspection area, or if consecutive empty ampoules defects are being detected.

AlarmsMisc

The AlarmsMisc routine contains alarms not related to running the system but operator errors when the operator enters data on the HMI.

AmpouleTracker

The purpose of the AmpouleTracker routine is to keep track of what specific ampoules are failing inspection. For example, in the Example provided herein, the long card contains 5 undivided cards, or portions, each of which is inspected prior to division therebetween. Every time a portion of the long card is inspected, the results are captured by a register. The register stores the result for each individual ampoule within the portion. The process is repeated 5 times during the inspection of the long card. If the inspection fails, the data is shifted into a larger register when the inspection finishes. The content of this register can be displayed on the HMI.

When the inspection fails, the end of the inspection process also copies data from a real time clock to a register. The data then becomes a time stamp, to be displayed below the picture of the failed long card.

The purpose of the routine is to have feedback for the user as to what ampoule is causing the long card to be not marked as a good one.

A user defined data type is used to communicate via Ethernet, the information from the vision sensor to the PLC. The function uses manufacturer specific parameters for the Ethernet Industrial Protocol for the settings. When GET VALUE is triggered by the VISION JOB FINISHED signal, the value of each of the individual ampoule results in the card is requested from predefined memory allocations in the vision sensor. The data is placed in GET VALUE RESULT; the file is copied to RESULT STRING in a string format. The data for the five ampoules is broken into individual ampoule status CHARACTER 1 thru CHARACTER 5, still in string format. Each individual character is converted to double integer format in NUMBER 1 thru NUMBER 5. The data in RESULT STRING belongs to the last card inspected, so do the results in NUMBER 1 thru NUMBER 5.

When the second vision sensor trigger takes place, the data in NUMBER 1 thru NUMBER 5 is moved to NEW.25 thru NEW.21. When the third trigger takes place, the data in NUMBER 1 thru NUMBER 5 is moved to NEW.20 thru NEW.16. When the fourth trigger takes place, the data in NUMBER 1 thru NUMBER 5 is moved to NEW.15 thru NEW.11. When the fifth trigger takes place, the data in NUMBER 1 thru NUMBER 5 is moved to NEW.10 thru NEW.6. When the long card leaves the VISION FINISH sensor, the data in NUMBER 1 thru NUMBER 5 is moved to NEW.5 thru NEW.1.

If LONG CARD BAD is enabled by the Inspection routine, the data in register NEW is moved to register AMPOULE for display in the HMI.

Counters

The counters routine contains counters with production data. The counters contain the number of long cards deflashed in the specific period of time or within the batch. There are counters for both filler and deflasher production numbers. The counters are reset by minute, hour, shift and batch change. Immediate previous numbers are kept until they are overwritten by the former current numbers when they are shifted to previous.

All the numbers in the counters may be in units of long cards. Multiplying the number of long cards by 5 gives the number of cards. Multiplying the number of long cards by 25 will provide the number of ampoules being inspected. These results are displayed in the HMI.

Another feature is the ability to display the number of cartons that could theoretically be filled with the number of ampoules available. This function simply divides the number of ampoules over the number of ampoules per carton entered by the operator.

Deflash

The Deflash routine controls the movement of the actuators associated with the deflashing process.

For a deflashing action to take place, a DEFLASH bit must be present at the time the long card is transferred from a pick position to a punch position. The bit DEFLASH is latched by the Inspection routine and it is unlatched when a DEFLASHING COMPLETE TIMER indicates the deflash routine is done.

If the good card bit is not enabled, the long card is not deflashed. A sensor in the left side will stop the left die before it is fully extended. The dies will exert enough pressure on the long card to hold it, but will not finish compressing the springs and will not punch out the cards from the flash. When the Inspection routine is disabled, the DEFLASH bit is skipped by parallel bit INSPECTION DISABLE.

InfeedBelt

The InfeedBelt routine controls the speed of the infeed belt by feeding an integer value into a formula that translates into a voltage output. The voltage output of the analog card is fed to the speed control input of a DC motor controller. The user setting works in terms of percentage, the analog card output works in terms of voltage.

Another function of this routine is to calculate the speed of the long card. It uses a timer to monitor how much time passes between the second and third image acquisition triggers. The result is run through equations that calculate the speed in inches per second and feet per minute, both of which are displayed in the HMI.

Inspection

The Inspection subroutine controls the vision sensor triggering and counts the results of the inspection.

The process starts when the leading edge of the long card makes it to a VISION START sensor. At that point the register for encoder counts is reset to 0 and the count starts. When the value of ENCODER is greater than the value of variable DISTANCE X, the vision sensor is triggered and the first image is acquired. DISTANCE X is the number of counts between the leading edge of the long card and the middle of the first card.

When the count of ENCODER is greater than the value of DISTANCE X plus DISTANCE Y, the vision sensor is triggered and acquires the second image. DISTANCE Y is the number of counts between cards.

When the count of ENCODER is greater than the value of DISTANCE X plus twice DISTANCE Y, the vision sensor is triggered and acquires the third image.

When the count of ENCODER is greater than the value of DISTANCE X plus three times DISTANCE Y, the vision sensor is triggered and acquires the fourth image.

When the count of ENCODER is greater than the value of DISTANCE X plus four times DISTANCE Y, the vision sensor is triggered and acquires the fifth and last image.

Each time the vision sensor is triggered, two signals are expected. One of the signals is VISION JOB FINISHED. The absence of this signal indicates the vision sensor is not working and triggers an alarm. The second one is the CARD OK signal, which indicates each of the five ampoules shown in the image appear to contain composition, for example, liquid solution.

The CARD OK pulses are counted by the GOOD FILLS counter with a preset of 5. When all five cards in the long card pass, the GOOD FILLS DONE bit latches LONG CARD OK 0. When the long card leaves the VISION FINISH sensor, the bit is transferred to LONG CARD OK 1. When the long card leave the VISION PAST sensor, the bit is transferred to LONG CARD OK 2. When the long card reaches the pick position, the bit is transferred to LONG CARD OK 3. When the long card is moved to the punch position, the bit is transferred to DEFLASH. The bit called DEFLASH must be active at the time the deflashing dies are coming together, for the process to complete. Otherwise, the process is halted before the left die completes its travel. The information in DEFLASH is used by the Deflash routine. DEFLASH is unlatched when the DEFLASHING COMPLETE TIMER is done.

Temperatures

The Temperatures routine does not influence the deflashing or inspection functions of the machine. Its purpose is to provide means to calibrate a thermocouple card used to monitor the temperatures, for example, in fill station chiller lines. For this, the routine contains multipliers for the raw values read by the thermocouples. In addition, it contains logic that forces mask bits used only during calibration.

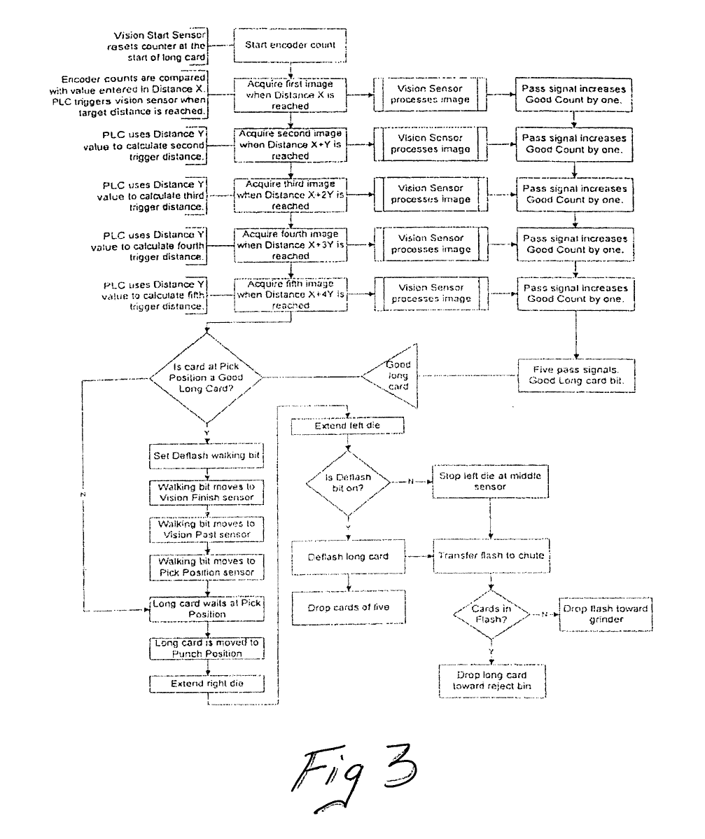

The end result of the work done by the above described exemplary Inspection and Deflash routines are represented by the flowchart shown in FIG. 3.

While this invention has been described with respect to various specific examples and embodiments, it is to be understood that the invention is not limited thereto and that it can be variously practiced within the scope of the following claims.

What is claimed is:

1. A method for inspecting a package having at least one ampoule, the method comprising:
positioning at least a portion of a package, having at least one ampoule, in an inspection position;
acquiring a digital image of the at least one ampoule while the package is in the inspection position;
processing the image to generate image data representing the at least one ampoule;
determining from the image data whether the at least one ampoule contains a desired composition;
deflashing the package if the image data indicates a presence of the composition in the at least one ampoule; and
rejecting the package without deflashing the package if the image data indicates that the at least one ampoule is substantially void of the composition.

2. The method of claim 1 wherein the steps of acquiring a digital image and analyzing the digital image are both accomplished by using an electronic vision sensor.

3. The method of claim 1 further comprising providing control data representing an empty ampoule and the step of determining includes comparing the image data with the control data.

4. The method of claim 1 wherein the generated image data represents a luminosity of the at least one ampoule.

5. The method of claim 4 further comprising providing control data representing a luminosity of an empty ampoule and the step of determining includes comparing the image data with the control data.

6. The method of claim 1 wherein the step of positioning comprises positioning only a portion of the package in the inspection position.

7. The method of claim 6 wherein the portion in the inspection position includes a plurality of ampoules.

8. The method of claim 7 wherein the step of acquiring a digital image comprises acquiring a digital image of each of the plurality of ampoules in the inspection position.

9. The method of claim 7 wherein the step of processing includes processing the image to generate image data representing each individual ampoule of the plurality of ampoules.

10. The method of claim 7 further comprising advancing the package such that another portion of the package is moved into the inspection position and the step of acquiring is performed on the another portion.

11. The method of claim 1 wherein the package includes a plurality of ampoules and each ampoule is imaged and processed.

12. The method of claim 7 wherein the step of deflashing the package is performed only if the image data indicates a presence of the composition in each one of the ampoules of the plurality of ampoules.

13. A method for verifying the presence of a composition in a package comprising contiguous portions, the method comprising:
providing a package having contiguous portions, the package to be inspected for verification of the presence of a composition in each portion;
providing a vision sensor having a field of view;
conveying the package along a conveyor such that a portion of the package is located within the field of view;
acquiring a digital image of the portion in the field of view by activating the vision sensor;
processing the image to verify whether the portion contains an amount of the composition;
further conveying the package along the conveyor such that each other portion of the package is consecutively moved into the field of view, and repeating, for each consecutive portion, the acquiring and processing steps; and
rejecting the package if any one of the portions is not verified as containing an amount of composition.

14. The method of claim 13 wherein each portion of the package comprises a plurality of ampoules for containing composition.

15. The method of claim 14 wherein the step of processing comprises processing the image to verify whether each ampoule of the portion contains an amount of the composition.

16. The method of claim 13 further comprising the step of dividing the portions, one from the other, if each of the portions is verified to contain the amount of the composition.

17. The method of claim 16 wherein the step of dividing comprises activating a deflashing mechanism to cut apart the portions, one from the other.

18. The method of claim 17 wherein the step of rejecting comprises activating the mechanism to secure the package in place without causing division of the portions one from the other.

19. A system for inspecting ampoule packages, the system comprising;
an optical sensor capable of acquiring an image of at least a portion of an ampoule package;
a processor capable of processing the image and generating data representing a condition of the package;
a controller in communication with the processor; and
a deflashing assembly responsive to the controller;
the controller being effective to control operation of the deflashing assembly such that the deflashing assembly is caused to perform a function on the package based on the condition of the package.

20. The system of claim 20 wherein the deflashing assembly comprises a hydraulic assembly includes a hydraulically operable deflashing assembly.

21. The system of claim 19 wherein the deflashing assembly is effective to divide the package into portions for further processing or packaging.

22. The system of claim 21 wherein the deflashing assembly is caused to divide the package only if the package has been determined from the image to contain no empty ampoules.

23. The system of claim 19 wherein the optical sensor and the processor are components of an integrated vision sensor capable of capturing digital images and processing the digital images.

24. The system of claim 23 wherein the vision sensor is effective to evaluate an illumination of each ampoule in the package.

25. The system of claim 19 wherein the processor includes a circuit effective to compare data representing an illumination of each ampoule of the package with control data representing a substantially empty ampoule.

26. The system of claim 19 further comprising a monitor for enabling viewing of the package or portion thereof during the imaging.
